(19) United States
(12) Patent Application Publication
(10) Pub. No.: US 2013/0222196 A1
(43) Pub. Date: Aug. 29, 2013

(54) WIRELESS DEVICE, AND INFORMATION PROCESSING APPARATUS AND STORAGE DEVICE INCLUDING THE WIRELESS DEVICE

(71) Applicants: Koh HASHIMOTO, Yokohama-shi (JP); Yukako Tsutsumi, Kawasaki-shi (JP); Takayoshi Ito, Yokohama-shi (JP); Koji Akita, Yokohama-shi (JP); Keiju Yamada, Yokohama-shi (JP)

(72) Inventors: Koh HASHIMOTO, Yokohama-shi (JP); Yukako Tsutsumi, Kawasaki-shi (JP); Takayoshi Ito, Yokohama-shi (JP); Koji Akita, Yokohama-shi (JP); Keiju Yamada, Yokohama-shi (JP)

(73) Assignee: Kabushiki Kaisha TOSHIBA, Tokyo (JP)

(21) Appl. No.: 13/603,864

(22) Filed: Sep. 5, 2012

(30) Foreign Application Priority Data
Feb. 28, 2012 (JP) 2012-041832

(51) Int. Cl. H01Q 1/38; H01Q 13/10

(52) U.S. Cl. 343/767; 343/700 MS

(57) ABSTRACT

According to one embodiment, a wireless device includes a circuit board, a semiconductor chip, a sealing resin, a conductive film, and an antenna element. The semiconductor chip includes a transmitting/receiving circuit and is mounted on the circuit board. The sealing resin seals the semiconductor chip. The conductive film covers a first surface portion of the sealing resin. An aperture is formed in a portion of the conductive film that corresponds to a second surface portion of the sealing resin other than the first surface portion, and the second surface portion is included in a side surface of the sealing resin and closest to an antenna terminal connected to the antenna element.

### CROSS-REFERENCE TO RELATED APPLICATIONS

This application is based upon and claims the benefit of priority from Japanese Patent Application No. 2012-041832, filed Feb. 28, 2012, the entire contents of which are incorporated herein by reference.

### FIELD

Embodiments described herein relate generally to a wireless device including a semiconductor package with a built-in antenna, and an information processing apparatus and a storage device including the wireless device.

### BACKGROUND

In the field of electronic devices, in accordance with increases in frequency and circuit density and decreases in size, interference due to undesired electromagnetic radiation has become problematic, and hence there is a demand for suppression of external leakage of the undesired electromagnetic radiation. In order to impart a shielding function to a semiconductor package, there is a method for covering, with a conductive resin layer, the surface of a non-conductive resin layer that seals a semiconductor chip. Further, a technique has been proposed, in which an aperture is formed at a portion of a non-conductive resin layer for sealing the semiconductor chip, and at a portion of a conductive resin layer that covers the upper surface of the semiconductor chip, thereby realizing a module with a built-in transmission/reception antenna that has a shielding function.

However, since in this technique, the aperture is positioned just above the semiconductor chip, the distance between the semiconductor chip generating undesired electromagnetic waves and the aperture is too short, which results in degradation of a shielding effect.

### BRIEF DESCRIPTION OF THE DRAWINGS

FIG. 1A is a top plane view schematically illustrating a wireless device according to a first embodiment;

FIG. 1B is a top plan view illustrating a state in which a conductive film is removed from the structure shown in FIG. 1A;

FIG. 1C is a cross-sectional view taken along line A-A′ of FIG. 1B;

FIG. 2A is a top plan view illustrating a state in which a conductive film is removed from a wireless device example that employs a dipole antenna as an antenna element;

FIG. 2B is a cross-sectional view taken along line A-A′ of FIG. 2A;

FIG. 3A is a top plan view illustrating a state in which a conductive film is removed from a wireless device example that employs a loop antenna as the antenna element;

FIG. 3B is a cross-sectional view taken along line A-A′ of FIG. 3A;

FIG. 4A is a top plan view illustrating a state in which a conductive film is removed from a wireless device example that employs a patch antenna as the antenna element;

FIG. 4B is a cross-sectional view taken along line A-A′ of FIG. 4A;

FIG. 5A is a top plan view illustrating a state in which a conductive film is removed from a wireless device example that employs a slot antenna as an antenna element;

FIG. 5B is a cross-sectional view taken along line A-A′ of FIG. 5A;

FIG. 6A is a top plane view schematically illustrating a wireless device according to a second embodiment;

FIG. 6B is a top plan view illustrating a state in which a conductive film is removed from the structure shown in FIG. 6A;

FIG. 6C is a cross-sectional view taken along line A-A′ of FIG. 6A;

FIG. 7A is a top plane view schematically illustrating a wireless device according to a third embodiment, and illustrating no conductive film;

FIG. 7B is a cross-sectional view taken along line A-A′ of FIG. 7A;

FIG. 8A is a top plane view schematically illustrating a wireless device according to a fourth embodiment;

FIG. 8B is a top plan view illustrating a state in which a conductive film is removed from the structure shown in FIG. 8A;

FIG. 8C is a cross-sectional view taken along line A-A′ of FIG. 8A;

FIG. 9A is a top plane view schematically illustrating a wireless device according to a fifth embodiment;

FIG. 9B is a top plan view illustrating a state in which a conductive film is removed from the structure shown in FIG. 9A;

FIG. 9C is a cross-sectional view taken along line A-A′ of FIG. 9A;

FIG. 10 is a block diagram illustrating a wireless device according to a seventh embodiment;

FIG. 11 is a view illustrating a wireless equipment example provided with a wireless device; and

FIG. 12 is a view illustrating a wireless device example mounted in a memory card.

### DETAILED DESCRIPTION

Wireless devices, an information processing apparatus and a storage device provided with the wireless devices, according to embodiments, will be described in detail with reference to the accompanying drawings. In the embodiments below, like reference numerals denote like elements, and duplicate descriptions will be avoided.

The embodiments have been developed in light of the above-mentioned problem, and aim to provide a wireless device having an antenna capable of efficiently radiating or receiving electromagnetic waves, with its shielding effect enhanced, and an information processing apparatus and a storage device provided with the wireless device.

According to one embodiment, a wireless device includes a circuit board, a semiconductor chip, a sealing resin, a conductive film, and an antenna element. The semiconductor chip includes a transmitting/receiving circuit and is mounted on the circuit board. The sealing resin seals the semiconductor chip. The conductive film covers a first surface portion of the sealing resin. An aperture is formed in a portion of the conductive film that corresponds to a second surface portion of the sealing resin other than the first surface portion, and the second surface portion is included in a side surface of the sealing resin and closest to an antenna terminal connected to the antenna element.

### First Embodiment

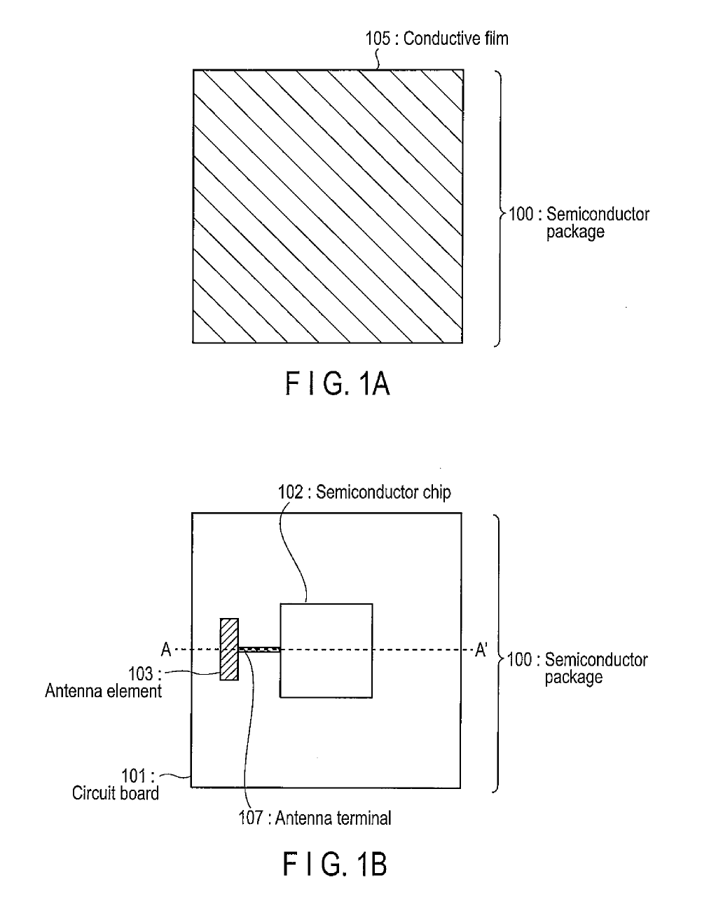

Referring first to FIGS. 1A, 1B and 1C, a wireless device of a first embodiment will be described. FIG. 1A is a top plane view schematically illustrating the wireless device according to the first embodiment. FIG. 1B is a top plan view illustrating a state in which a conductive film is removed from the wireless device. FIG. 1C is a cross-sectional view taken along line A-A′ of FIG. 1B. In FIG. 1C, conductive film is not omitted.

The wireless device shown in FIGS. 1A to 1C comprises a circuit board 101, a semiconductor chip 102, an antenna element 103, a sealing resin 104, a conductive film 105, terminals 106, and an antenna terminal 107. The wireless device will hereinafter be also referred to as a semiconductor package. In the figures, the semiconductor package is denoted by reference numeral 100.

The semiconductor chip 102 is provided on a first surface of the circuit board 101, and contains a transmitting/receiving circuit for transmitting and receiving signals. The terminals 106 are provided on a second surface of the circuit board 101. The first and second surfaces are opposite to each other. Namely, if the first surface is the upper surface, the second surface is the lower surface. The semiconductor chip 102 is sealed with the sealing resin 104. The semiconductor chip 102 comprises a semiconductor substrate made of silicon, silicon germanium, gallium arsenide, etc., and having a patterned metal layer of, for example, copper, aluminum, or gold provided in the chip or a surface thereof. The semiconductor chip 102 may be formed of a dielectric substrate, a magnetic substrate, a metal substrate, or a combination thereof. The semiconductor chip 102 may also be formed of a chip size package (CSP). Although FIGS. 1A to 1C show only one semiconductor chip 102, a plurality of semiconductor chips may be stacked or arranged horizontally. The semiconductor chip 102 is electrically connected to the wiring and the ground terminals (not shown) of the circuit board 101 via bonding wires, bumps, etc.

The antenna element 103 is provided on a portion of the first surface of the circuit board 101 other than the portion of the board provided with the semiconductor chip 102. The semiconductor chip 102 and the antenna element 103 are formed with a certain space interposed therebetween. The semiconductor chip 102 and the antenna element 103 are sealed with the sealing resin 104. The antenna element 103 is connected to the antenna terminal 107 that is electrically connected to the semiconductor chip 102. The antenna terminal 107 is positioned at the tip of a transmission line electrically connected to the semiconductor chip 102 via, for example, a bonding wire or a bump. The antenna element 103 is formed of part of an antenna or of the entire antenna. The antenna element 103 may be formed on the circuit board 101 as shown in FIGS. 1A to 1C, or be formed of, for example, a bonding wire or a bump (not shown). The antenna element 103 is, for example, a dipole antenna, a loop antenna, a patch antenna or a slot antenna. The antenna element 103 and the antenna terminal 107 may be directly connected to each other (direct current connection), or be electrically connected by electromagnetic coupling when the frequency is high.

Although greater part of the sealing resin 104 is covered with the conductive film 105, the side surface of the sealing resin 104 (semiconductor package 100) closest to the antenna terminal 107 is covered with no conductive film 105. The side surface of the sealing resin 104 covered with no conductive film 105 will hereinafter be referred to as an aperture 108. The aperture 108 is formed at a side surface of the sealing resin closest to the antenna terminal 107 connected to the antenna element 103.

To prevent the undesired electromagnetic waves generated by the semiconductor chip 102 from leaking to the outside, it is desirable to form the conductive film 105 of a metal with a low specific resistance, such as copper, silver or nickel. For instance, it is preferable to set the thickness of the conductive film 105 so that the sheet resistance obtained by dividing the specific resistance of the conductive film 105 by the thickness of the same will be 0.5Ω or less. By setting the sheet resistance of the conductive film 105 to 0.5Ω or less, leakage of undesired electromagnetic waves can be suppressed with good repeatability.

A high shielding effectiveness can be obtained if the conductive film 105 is connected to a ground terminal of the circuit board 101 with a low resistance. In FIGS. 1A to 1C, the conductive film 105 is in contact with a side surface of the circuit board 101 and connected to a ground terminal (not shown) of the same at the side surface.

The aperture 108 is formed in the portion of the conductive film 105 that corresponds to the side surface of the sealing resin 104 closest to the antenna terminal 107, and enables radiation and reception of desired electromagnetic waves for communication. The distance between the semiconductor chip 102 and the aperture 108 can be made longer than in the case where the aperture is formed in the upper surface of the conductive film 105. Therefore, the shielding effectiveness against the undesired electromagnetic waves generated by the semiconductor chip 102 is enhanced. Thus, by forming the aperture 108 in the side surface of the conductive film 105 closest to the antenna terminal 107, transmission loss can be reduced, and degradation of antenna radiation characteristic can be suppressed.

The semiconductor package 100 shown in FIGS. 1A to 1C is a ball grid array (BGA) package in which the terminals 106 formed of solder balls are provided on the second surface of the circuit board 101. The semiconductor package 100 is not limited to the BGA package, but may be another type of package or a module comprising a semiconductor chip and a substrate. On the portion of the circuit board 101 covered with the sealing resin 104, components, such as a chip capacitor and IC (not shown), may be mounted, as well as the semiconductor chip 102 and the antenna element 103. Further, in FIG. 1B, the semiconductor chip 102 and the semiconductor package 100 are square components. However, they are not limited to square ones, but may be formed rectangular, polygonal or circular, or may have other complex shapes. In other words, the outline defined by the sealing resin 104 may have a rectangular, polygonal or circular shape, or other complex shapes.

In FIG. 1C, the entire side surface is formed as the aperture 108. However, if the aperture is formed smaller within a range in which desired electromagnetic waves can be radiated and received, highly efficient radiation and reception of the desired electromagnetic waves, and a high shielding effectiveness against undesired electromagnetic waves can be realized simultaneously.

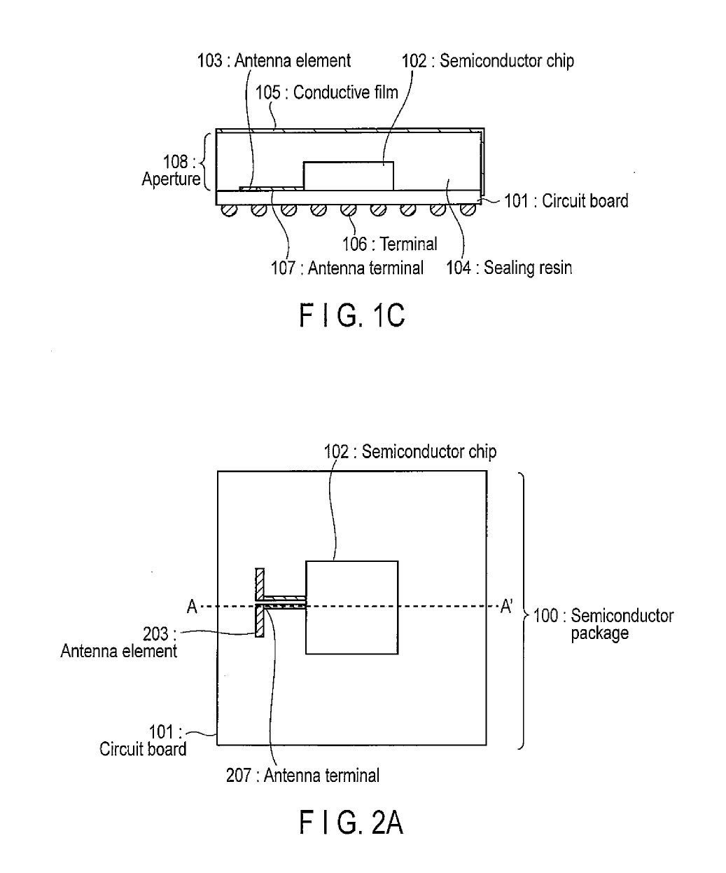

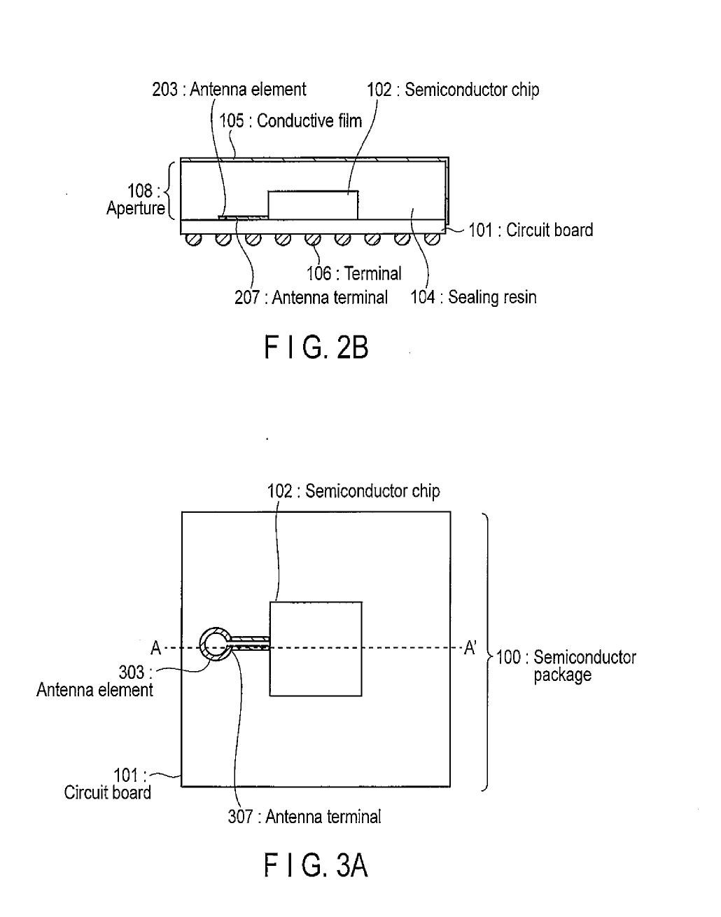

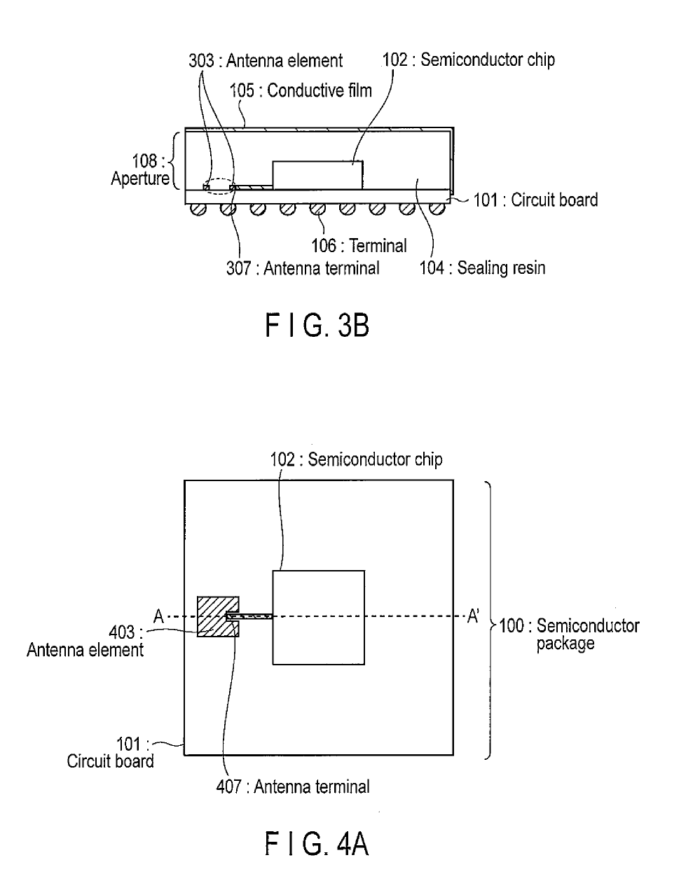

Referring then to FIGS. 2A, 2B, 3A, 3B, 4A, 4B, 5A, 5B, 6A and 6B, modifications of the radiation (antenna) element will be described. These figures show radiation elements used in place of the antenna element 103 shown in FIGS. 1A and 1B. Note that in FIGS. 2A, 3A, 4A and 5A, the sealing resin 104, the conductive layers 106 and the conductive wall 107 are omitted.

FIGS. 2A, 3A, 4A and 5A show cases where the antenna element 103 shown in FIG. 1B is a dipole antenna, a loop antenna, a patch antenna, and a slot antenna, respectively.

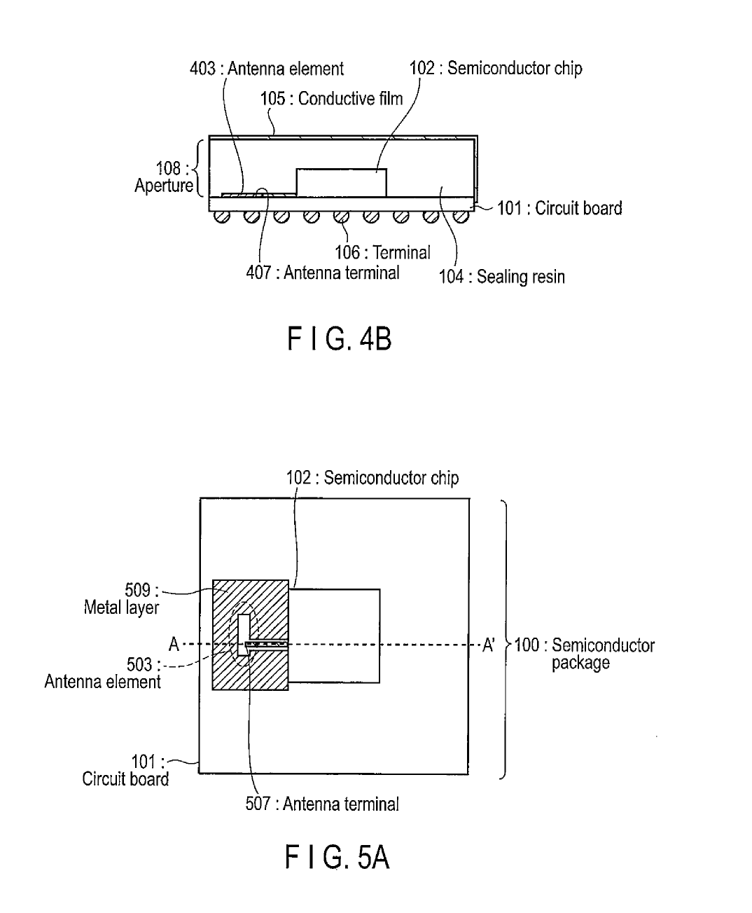

In FIG. 5, the slot serving as an antenna 103 is formed in a metal layer 509 incorporated in the circuit board. The antenna element 103 may be an antenna other than the dipole antenna, the loop antenna, the patch antenna and the slot antenna. Further, in each of FIGS. 1A to 5B, only one antenna 103 is employed. However, a plurality of antennas may be employed.

In the above-described first embodiment, since the aperture is formed in the portion of the conductive film that corresponds to the side surface of the semiconductor package closest to the antenna terminal, degradation of the antenna radiation characteristic can be suppressed, with degradation of the shielding effectiveness against undesired electromagnetic waves suppressed.

### Second Embodiment

A wireless device according to a second embodiment differs from the wireless device of the first embodiment in that in the former, an aperture is formed over a plurality of surfaces of the semiconductor package that include the side surface closest to the antenna terminal.

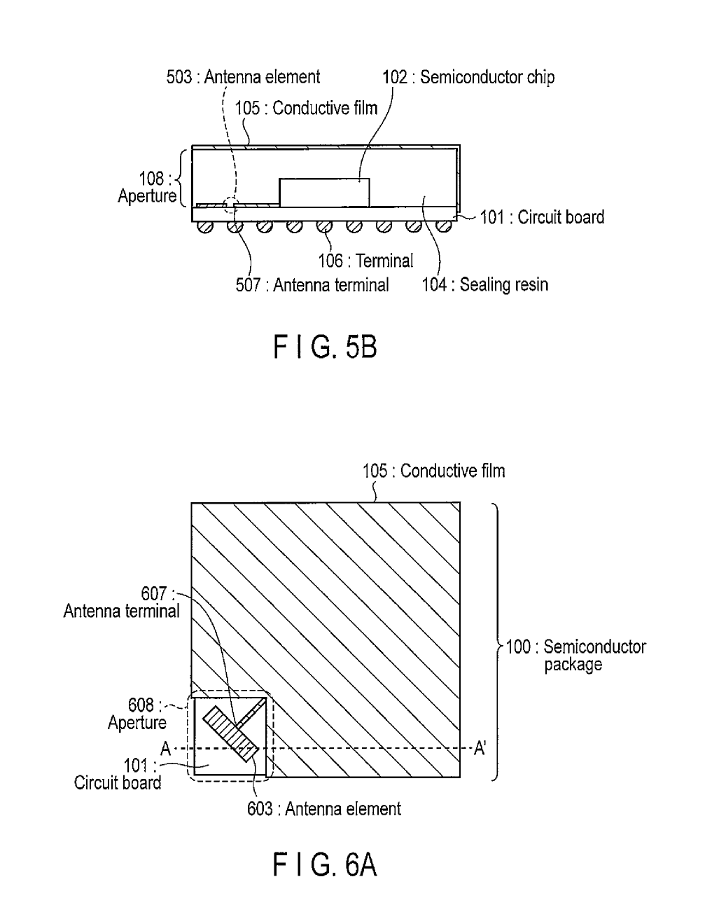

Referring to FIGS. 6A, 6B and 6C, the wireless device of the second embodiment will be described. FIG. 6A is a top plane view schematically illustrating the wireless device of the second embodiment. FIG. 6B is a top plan view illustrating a state in which a conductive film and a sealing resin are removed. FIG. 6C is a cross-sectional view taken along line A-A′ of FIG. 6A. In FIG. 6C, the conductive film is not omitted.

By forming a continuous aperture 608 in the conductive film 105 over a plurality of surfaces of the semiconductor package 100, the main radiation direction of an antenna element 603 can be directed from the antenna element 603 to the aperture 608. Thus, the degree of freedom for setting the radiation direction is increased.

In the above-described second embodiment in which the aperture is provided above the antenna element, the radiation efficiency of the antenna can be improved. Further, by forming a continuous aperture in a conductive film over plural surfaces of the semiconductor package, the degree of freedom for setting the radiation direction is increased.

### Third Embodiment

A wireless device of a third embodiment differs from those of the first and second embodiments in that in the former, an aperture itself serves as an antenna.

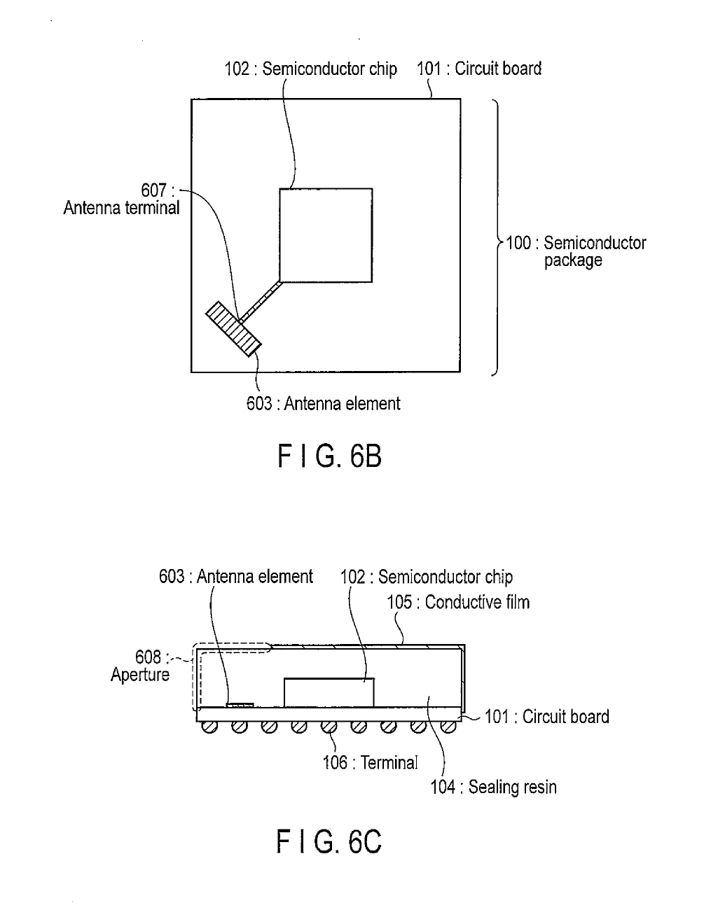

Referring to FIGS. 7A and 7B, the wireless device of the third embodiment will be described. FIG. 7A is a top plane view schematically illustrating the wireless device of the third embodiment. In FIG. 7A, no conductive film is shown. FIG. 7B is a cross-sectional view taken along line A-A′ of FIG. 7A. In FIG. 7B, the conductive film is not omitted.

By setting the length (in a longitudinal direction) of an aperture 708 in the conductive film 105 to substantially half the wavelength of a desired electromagnetic wave, the aperture 708 can serve as a slot antenna. Namely, the aperture 708 serves as an antenna element. In this case, since the aperture can be formed smaller than in the case where another type of antenna is used, electromagnetic waves can be efficiently radiated and received.

In the wireless device of the third embodiment, a smaller aperture can be formed than in the case where another type of antenna element is mounted on a circuit board and an aperture is formed in a conductive film, with the result that desired electromagnetic waves can be radiated and received more efficiently, thereby realizing a higher shielding performance.

Where a horizontal slot is formed as shown in FIGS. 7A and 7B, vertically polarized waves can be radiated to the direction substantially normal to the side surface in which the slot is cut. To feed the slot, a method using an antenna terminal 707 and a via 709 in the circuit board 101 may be employed.

As described above, in the third embodiment, the length of the aperture is set to substantially half the wavelength of the desired electromagnetic wave, thereby using the aperture itself as a slot antenna. Since in this case, the aperture can be formed smaller than in the case of using other types of antennas, electromagnetic waves can be efficiently radiated and received with a high shielding effect maintained.

### Fourth Embodiment

A wireless device according to a fourth embodiment differs from those of the first to third embodiments in that the former employs a slot antenna that comprises an aperture extending from the upper surface of a semiconductor package to a side surface thereof.

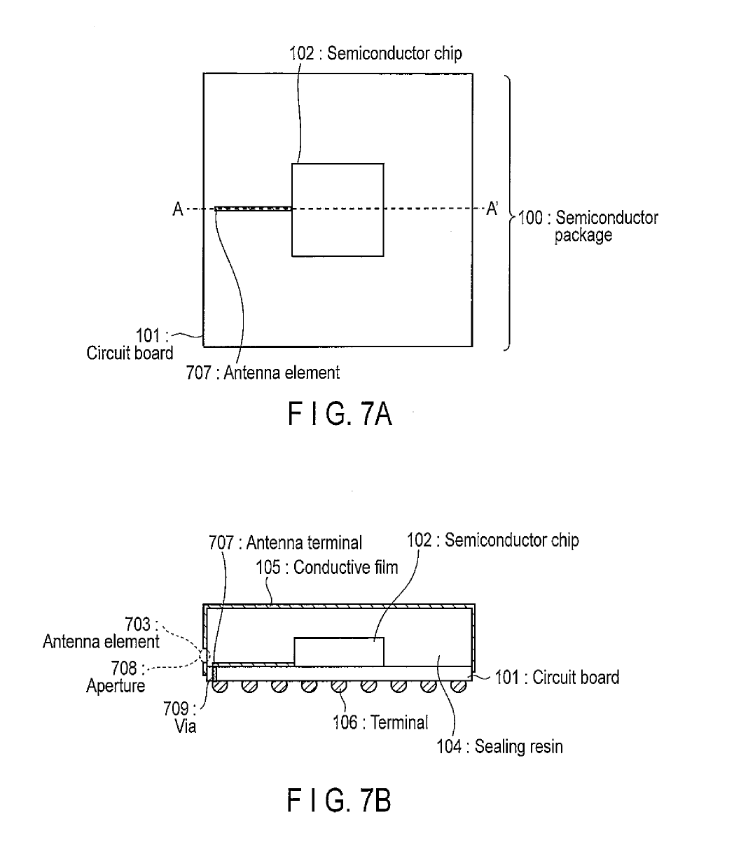

Referring to FIGS. 8A, 8B and 8C, the wireless device of the fourth embodiment will be described. FIG. 8A is a top plane view schematically illustrating the wireless device of the fourth embodiment. FIG. 8B is a top plan view illustrating a state in which a conductive film is removed from the structure of FIG. 8A. FIG. 8C is a cross-sectional view taken along line A-A′ of FIG. 8A. In FIG. 8C, the conductive film is not omitted.

In a structure utilizing a slot antenna, in order to radiate horizontally polarized waves in a package lateral direction with a high shielding performance realized, vertically elongated aperture is formed in a side surface of the package, as in the third embodiment. However, if the height of the package is less than substantially half the wavelength of a desired electromagnetic wave, the resonant length of the slot cannot be accommodated.

In this case, if an L-shaped aperture 808 extending from a side surface of the package to its top surface as shown in FIGS. 8A to 8C, the resonant length (longitudinal dimension) of the slot can be accommodated, thereby enabling desired electromagnetic waves to be efficiently radiated and received. In the case of using the L-shaped slot shown in FIGS. 8A to 8C, electromagnetic waves are radiated to a direction obliquely upward from the horizontal plane.

Since in the fourth embodiment, the aperture is formed in the conductive film over a plurality of surfaces of the semiconductor package, the radiation direction of electromagnetic waves can be set more freely. Further, by using the aperture extended from the side surface to the top surface of the package, the radiation efficiency of the antenna can be enhanced.

### Fifth Embodiment

A wireless device according to a fifth embodiment differs from the first to fourth embodiments in that the former employs a slot antenna having an aperture thereof extended over an upper surface, a side surface and a lower surface.

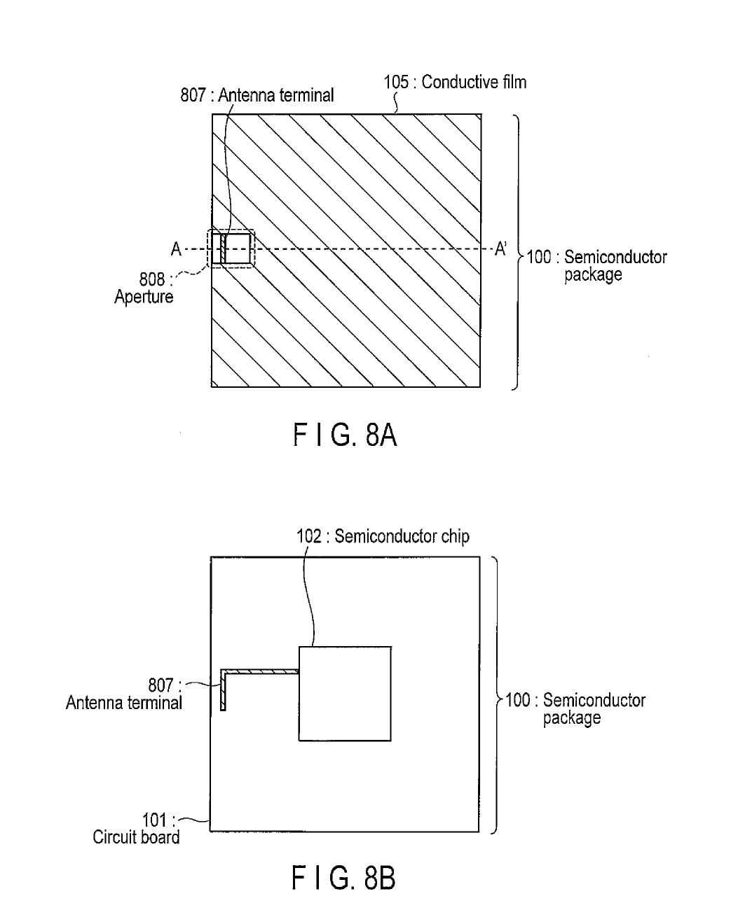

Referring to FIGS. 9A, 9B and 9C, the wireless device of the fifth embodiment will be described. FIG. 9A is a top plane view schematically illustrating the wireless device of the fifth embodiment. FIG. 9B is a top plan view illustrating a state in which a conductive film is removed from the structure shown in FIG. 9A. FIG. 9C is a cross-sectional view taken along line A-A′ of FIG. 9A. In FIG. 9C, the conductive film is not omitted.

When an L-shaped slot is used as in the fourth embodiment, the radiation direction of the antenna is obliquely upward from the horizontal plane. Thus, the L-shaped slot antenna is not suitable for horizontal or obliquely downward radiation.

In the fifth embodiment, an aperture 908 is also extended to a metal layer 909 in the circuit board 101 as shown in FIGS. 9A to 9C. Namely, the aperture 908 is extended from the top surface of the package to the metal layer 909 in the circuit board 101 via a side surface of the package, thereby providing a U-shaped slot antenna. The metal layer 909 is electrically connected to the conductive film 105. In FIGS. 9A to 9C, the metal layer is provided on the entire surface of the circuit board except for the aperture 908. However, another aperture and/or transmission lines may be provided on the circuit board. By setting the entire length of the U-shaped aperture to substantially half the wavelength of a desired electromagnetic wave, the desired electromagnetic waves can be efficiently radiated and received. In other words, the aperture 908 is formed in part of the surface of the sealing resin 104 that is not coated with the conductive film 105 or the metal layer 909.

In the case where the U-shaped slot shown FIGS. 9A to 9C is used, the radiation direction of the antenna can be controlled to an obliquely upward direction, a horizontal direction and an obliquely downward direction by adjusting the length of the aperture in the top surface of the package and the length of the aperture in the metal layer on the circuit board.

Since in the above-described fifth embodiment, the aperture is formed in the conductive film and the metal layer on the circuit board over three surfaces of the semiconductor package, the fifth embodiment can provide an advantage that the radiation direction of electromagnetic waves can be varied more freely to thereby further enhance the radiation efficiency of the antenna, as well as the advantage of the third embodiment.

### Sixth Embodiment

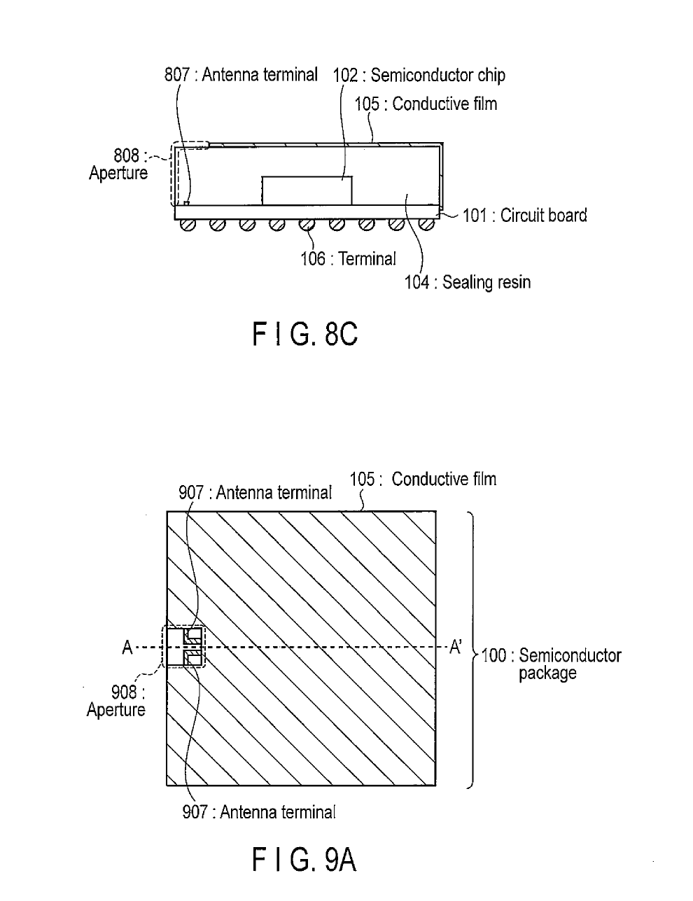

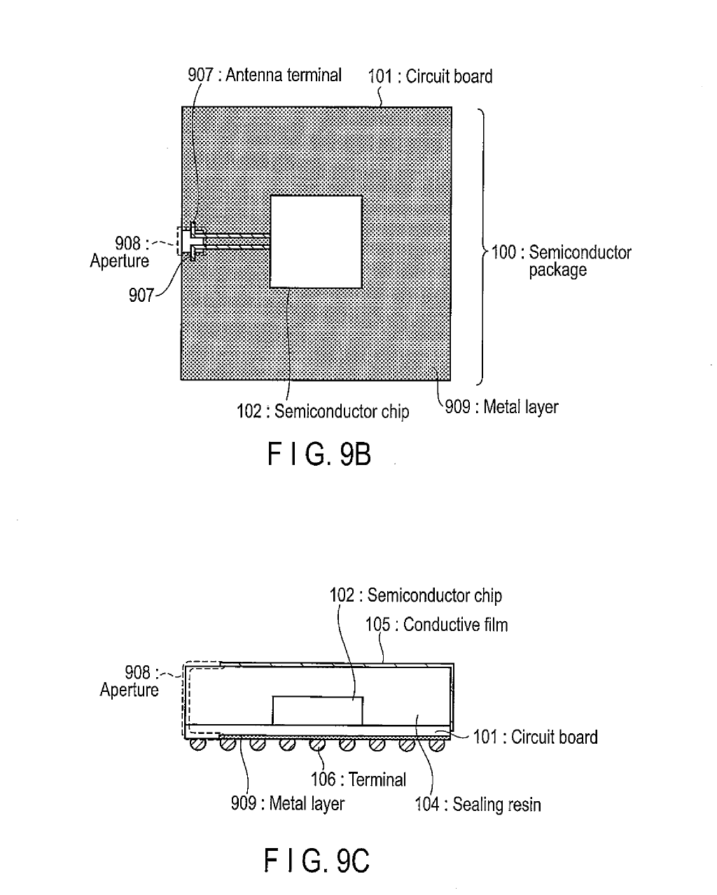

Referring now to FIGS. 10 and 11, a description will be given of an information processing apparatus and a storage device according to a sixth embodiment, which incorporate one of the wireless devices according to the first to fifth embodiments.

The information processing apparatus is a generic name of wireless equipments that incorporate one of the above-mentioned wireless devices and perform exchange of data and still and moving images.

As shown in FIG. 10, a wireless equipment 1000 comprises a wireless device 100, a processor 1001 and a memory 1002.

The wireless device 100 transmits and receives data to and from an external device. The wireless device 100 is formed of one of the semiconductor packages 100 according to the first to fifth embodiments.

The processor (also called a controller) 1001 processes data received from and transmitted to the wireless device 100.

The memory 1002 stores data received from and transmitted to the processor 1001.

Referring then to FIG. 11, examples of the wireless equipment with the wireless device 100 will be described.

In these examples, the wireless equipment examples are a laptop personal computer (laptop PC) 1101 and a mobile terminal 1102. The laptop PC 1101 and the mobile terminal 1102 comprise displays 1103 and 1104 for displaying still and moving images. Each of the laptop PC 1101 and the mobile terminal 1102 also comprises a central processing unit (CPU) (also called a controller), a memory, etc. Each of the laptop PC 1101 and the mobile terminal 1102 further comprises an internal or external wireless device 100, through which data communication is performed using a frequency of, for example, a millimeter-wave band. In the sixth embodiment, the laptop PC 1101 and the mobile terminal 1102 may incorporate the semiconductor package 100 according to any one of the aforementioned embodiments.

Further, if the wireless devices incorporated in the laptop PC 1101 and the mobile terminal 1102 are arranged so that their directions, in which high directivity is obtained, are opposed to each other, data exchange therebetween can be performed with high efficiency.

Although FIG. 11 shows the laptop PC 1101 and the mobile terminal 1102, the sixth embodiment is not limited to them, but the wireless devices may be mounted in, for example, a television receiver, a digital camera, a memory card, etc.

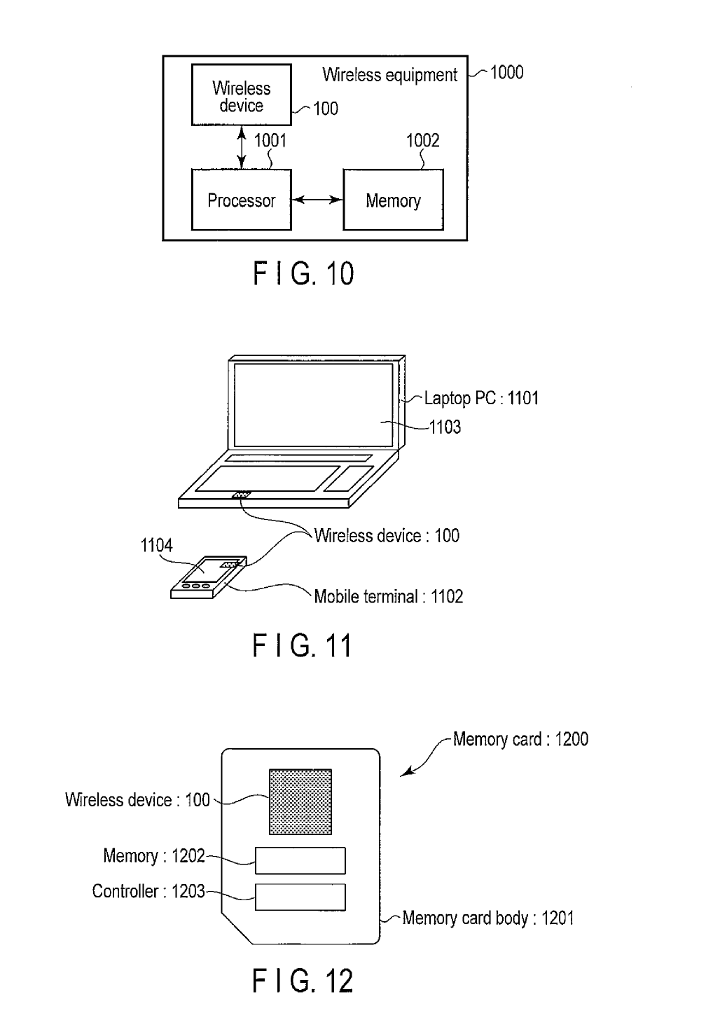

Referring then to FIG. 12, a description will be given of a case where the wireless device is installed in a storage device. In the example of FIG. 11, the storage device is a memory card 1200.

As shown in FIG. 12, the memory card 1200 comprises the wireless device 100 and a memory card body 1201, and can communicate with, for example, a laptop PC, a mobile terminal, or a digital camera, via the wireless device 100. The memory card proper 1201 comprises a memory 1202 for storing information, and a controller 1203 for controlling the entire device.

In the above-described sixth embodiment, by installing the wireless device (semiconductor package 100) according to one of the first to fifth embodiments in an information processing apparatus or storage device, such as a laptop PC, a mobile terminal, or a memory card, which performs wireless data communication, data transmission and reception can be performed with high efficiency, with degradation of the shielding effect against undesired electromagnetic waves suppressed, and with degradation of antenna radiation characteristic suppressed.

In the embodiments described above, by forming the aperture in the portion of the conductive film provided on the side surface of the semiconductor package closest to the antenna terminal, degradation of the radiation characteristic of the antenna can be suppressed with degradation of the shielding effect thereof against undesired electromagnetic waves suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless device comprising:
a circuit board;
a semiconductor chip comprising a transmitting/receiving circuit and mounted on the circuit board;
a sealing resin configured to seal the semiconductor chip;
a conductive film configured to cover a first surface portion of the sealing resin; and
an antenna element,
wherein an aperture is formed in a portion of the conductive film that corresponds to a second surface portion of the sealing resin other than the first surface portion, and the second surface portion is included in a side surface of the sealing resin and closest to an antenna terminal connected to the antenna element.

2. The device according to claim 1, wherein the aperture is formed over a plurality of surfaces of the sealing resin when the sealing resin is polygonal.

3. The device according to claim 2, wherein the aperture serves as the antenna element.

4. The device according to claim 3, wherein the aperture has a longitudinal dimension set to half a wavelength of a desired electromagnetic wave.

5. The device according to claim 4, further comprising a metal layer provided on the circuit board and electrically connected to the conductive film, and wherein the aperture is formed in the portion of the conductive film that corresponds to the second surface portion, or in the metal layer.

6. The device according to claim 3, further comprising a metal layer provided on the circuit board and electrically connected to the conductive film, and wherein the aperture is formed in the portion of the conductive film that corresponds to the second surface portion, or in the metal layer.

7. The device according to claim 1, wherein the aperture serves as the antenna element.

8. The device according to claim 7, further comprising a metal layer provided on the circuit board and electrically connected to the conductive film, and wherein the aperture is formed in the portion of the conductive film that corresponds to the second surface portion, or in the metal layer.

9. The device according to claim 7, wherein the aperture has a longitudinal dimension set to half a wavelength of a desired electromagnetic wave.

10. The device according to claim 9, further comprising a metal layer provided on the circuit board and electrically connected to the conductive film, and wherein the aperture is formed in the portion of the conductive film that corresponds to the second surface portion, or in the metal layer.

11. An information processing apparatus comprising:
the wireless device according to claim 1;
a controller configured to process data transmitted to and received from the wireless device;
a memory configured to store the data; and
a display configured to display an image corresponding to the data.

12. An information processing apparatus comprising:
the wireless device according to claim 2;
a controller configured to process data transmitted to and received from the wireless device;
a memory configured to store the data; and
a display configured to display an image corresponding to the data.

13. An information processing apparatus comprising:
the wireless device according to claim 3;
a controller configured to process data transmitted to and received from the wireless device;
a memory configured to store the data; and
a display configured to display an image corresponding to the data.

14. An information processing apparatus comprising:
the wireless device according to claim 7;
a controller configured to process data transmitted to and received from the wireless device;
a memory configured to store the data; and
a display configured to display an image corresponding to the data.

15. An information processing apparatus comprising:
the wireless device according to claim 8;
a controller configured to process data transmitted to and received from the wireless device;
a memory configured to store the data; and
a display configured to display an image corresponding to the data.

16. A storage device comprising:
the wireless device according to claim 1;
a controller configured to process data transmitted to and received from the wireless device; and
a memory configured to store the data.

17. A storage device comprising:
the wireless device according to claim 2;
a controller configured to process data transmitted to and received from the wireless device; and
a memory configured to store the data.

18. A storage device comprising:
the wireless device according to claim 3;
a controller configured to process data transmitted to and received from the wireless device; and
a memory configured to store the data.

19. A storage device comprising:
the wireless device according to claim 7;
a controller configured to process data transmitted to and received from the wireless device; and
a memory configured to store the data.

20. A storage device comprising:
the wireless device according to claim 8;
a controller configured to process data transmitted to and received from the wireless device; and
a memory configured to store the data.
